(19) United States
(12) Patent Application Publication
(10) Pub. No.: US 2008/0105046 A1
(43) Pub. Date: May 8, 2008

(54) Microelectronic flow sensor packaging method and system

(75) Inventor: Lamar F. Ricks, Lewis Center, OH (US)

Correspondence Address: Bryan Anderson;Honeywell International Inc., 101 Columbia Rd., P.O. Box 2245, Morristown, NJ, 07962, US

(73) Assignee: Honeywell International Inc.

(21) Appl. No.: 11/593,311

(22) Filed: Nov. 3, 2006

(51) Int. Cl. G01F 15/00

(52) U.S. Cl. 73/198

(57) ABSTRACT

A microelectronic packaging method and system for minimizing the distance between the sensing plane of a MEMS flow sensor and a mounting substrate thereof. Flow obstructions are minimized and laminar flow maintained in order to enhance flow sensor optimal performance. The distance between the sensing plane and the mounting substrate can be controlled by optimizing the dimensions of an associated carrier with respect to the thickness of the MEMS flow sensor. Ideally, the sensing plane of the MEMS flow sensor is located at the same level as the mounting substrate or just slightly higher.

### TECHNICAL FIELD

Embodiments are generally related to sensor devices. Embodiments are also related to the field of microelectronic packaging. Embodiments are additionally related to MEMS (Microelectromechanical System) flow sensors.

### BACKGROUND OF THE INVENTION

Many processes and devices have been used to sense or measure the velocity, pressure, or flow rate of a fluid. Such systems or devices typically contain fluids (e.g., liquids and/or gases) subject to both internal and external flow. Systems and devices have been developed including “hot wire” based sensing components and devices that measure velocity or flow rate indirectly by detecting pressure or pressure differences. Sensors that measure velocity or flow rate indirectly by detecting pressure or pressure differences include those that use structures that extend into the flow stream such as pitot tubes, and those that measure from the side of the flow stream such as venturi meters.

MEMS-based sensors have been implemented, which include the use of angular speed and acceleration sensors formed by MEMS-type manufacturing techniques. MEMS sensors of this type typically include a substrate, a mass body disposed relative to the substrate and which can oscillate in a vertical direction, along with two or more capacitors formed between the substrate and the mass body. Each element of the MEMS sensor can be made very small when formed utilizing semiconductor manufacturing technology. MEMS oscillatory devices may be far less susceptible to wear and breakdown than MEMS rotary devices, such as fans.

Since the 1980's, airflow and liquid flow sensors have been utilized based on MEMS microbridge transducers that function according to thermal anemometry principles. A great deal of care is often taken with the package design to ensure that the MEMS flow sensor is exposed to a media with laminar flow. In the early days of such devices, package designs were developed based on principles of physics, empirical data and engineering judgment. More recently, powerful design tools such as software simulation have allowed sensor designers to take package design optimization to a new level.

One prior art sensor design for sensing the motion or pressure of a fluid, involves the use of components having dimensions less than 1.5 inches, a metal lead frame with a coefficient of thermal expansion which can be less than that of the body, and/or the use of two or more resistive thermal devices (RTDs) and a heat source The building block for such a design may be a thermoplastic or thermoset overmolded leadframe that forms an assembly and serves both a mechanical and an electrical purpose. A pocket can be molded in the custom leadframe assembly and the MEMS flow sensor can be placed in the pocket and attached with a wire bonding process. The distance between the sensing plane and the bottom of the media flow channel can be controlled by the depth of the molded pocket and the thickness of the MEMS flow sensor. In this packaging method, the tooling to make the custom over molded leadframe assembly can be quite complicated and expensive. Ultimately what is produced is a building block which can be used as a surface mount device. To form the electrical connections, this building block would have to be soldered to a substrate that contains the rest of the sensor electronics. This can be a time consuming and inefficient approach.

Referring to FIG. 1, a cross-sectional view of a prior art flow sensor system 100 illustrated, which is indicative of flow simulations and prototype testing for MEMS-based flow sensors. Flow simulations and prototype testing has demonstrated that the transfer function or electrical output signal of a MEMS flow sensor 106 is directly affected by the distance between the sensing plane 108 of the MEMS flow sensor 106 and the substrate 112 to which it is mounted. The reason this is true is because the thickness of the MEMS flow sensor 106 serves as an obstruction in the flow path and changes the laminar flow characteristics of the sensed media indicated by a double-arrow 104 by generating turbulence. Optimal signals can be achieved by minimizing the distance “d” 110 between the sensing plane 108 of the MEMS flow sensor 106 and the mounting substrate 112, ideally placing the sensing plane 108 at the same level as the mounting substrate or just slightly above. The top wall of flow channel 102 can be associated with the flow direction of media indicated by the double-arrow 104.

Accordingly, a need exists for developing a new microelectronic packaging method that can be used to minimize the distance between the sensing plane of the MEMS flow sensor and the mounting substrate to minimize flow obstructions and maintain laminar flow and optimal performance.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved flow-sensor sensor device.

It is another aspect of the present invention to provide for improved microelectronic packaging for slow-sensors.

It is a further aspect of the present invention to provide for a technique for optimizing the distance between the sensing plane of a MEMS-based flow sensor and a mounting substrate thereof. The aforementioned aspects and other objectives and advantages can now be achieved as described herein. A MEMS-based microelectronic packaging method and system are disclosed. In general, a mounting substrate can be provided for a MEMS flow sensor. The distance between a sensing plane of the MEMS flow sensor and the mounting substrate is minimized. A plurality of flow obstructions associated with the MEMS flow sensor is also minimized. The MEMS flow sensor laminar flow is maintained based on the relationship between the flow obstructions and the distance between the sensing plane and the mounting substrate, thereby optimizing the performance of the MEMS flow sensor. The distance between the sensing plane of the MEMS flow sensor and the mounting substrate is also optimized.

Additionally, the mounting substrate is mounted to a desired distance by incorporating a carrier. The MEMS flow sensor can be attached to the carrier utilizing a screen-printed die-attaching material. The MEMS flow sensor can be located onto the carrier and an adhesive applied, wherein the adhesive is cured with exposure to an optimal combination of time and temperature. The carrier forms part of a carrier assembly which is attached to the mounting substrate. The carrier assembly can be cured with an exposure to an optimal combination of time and temperature. Additionally, the MEMS flow sensor may be wire bonded to the mounting substrate such that electrical connections associated with the flow sensor are made available to a remainder of at leas one sensor circuit associated with the MEMS flow sensor.

Such a method and system can effectively control the distance between the sensing plane and the mounting substrate, which in this case can also be at the bottom of the media flow channel. This can be achieved by optimizing the dimensions of the carrier considering the thickness of the MEMS flow sensor. Ideally, the sensing plane of the MEMS flow sensor can be at the same level as the mounting substrate or just slightly higher. Essentially one more component (i.e., the carrier) is needed in the new packaging method and system described herein, but it adds a significant performance improvement for a very minimal increase in material and processing.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a cross sectional view of a prior art flow sensor system indicative of flow simulations and prototype testing for MEMS flow sensors;

FIG. 2 illustrates a cross section view of IP packaging for microelectronic packaging method to optimize the distance between the sensing plane of a MEMS flow sensor and the mounting substrate, which can be implemented in accordance with a preferred embodiment;

FIG. 3 illustrates a cross section view of IP packaging with ideal design conditions for microelectronic packaging method to optimize the distance between the sensing plane of a MEMS flow sensor and the mounting substrate, which can be implemented in accordance with a preferred embodiment; and

FIG. 4 illustrates a high-level flow chart of operations for microelectronic packaging method to optimize the distance between the sensing plane of a MEMS flow sensor and the mounting substrate, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

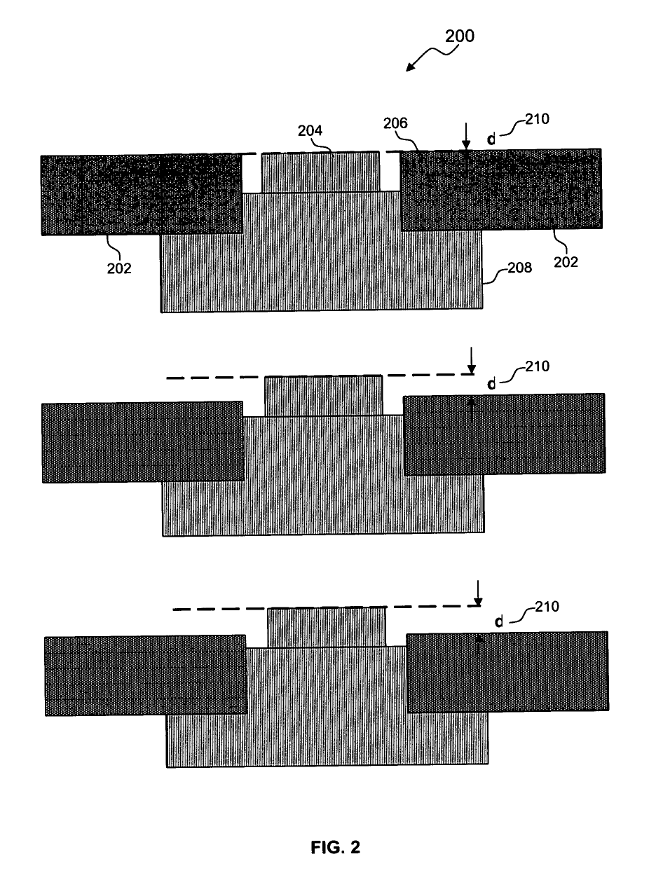

Referring now to the drawings and in particular to FIG. 2, a cross-sectional view of a microelectronic packaging system 200 for optimizing the distance between the sensing plane of a MEMS flow sensor and a mounting substrate thereof is illustrated, in accordance with a preferred embodiment. The distance between a sensing plane 206 of a MEMS flow sensor 204 and a substrate 202 to which it is mounted can be optimized to a desired distance by incorporating a carrier 208. The distance ‘d’ 210 can be easily modified by changing the dimensions of the carrier 208. The carrier 208 can be made of materials such as thermoplastic, ceramic, or any material with acceptable mechanical properties to achieve adequate matching of thermal expansion coefficients.

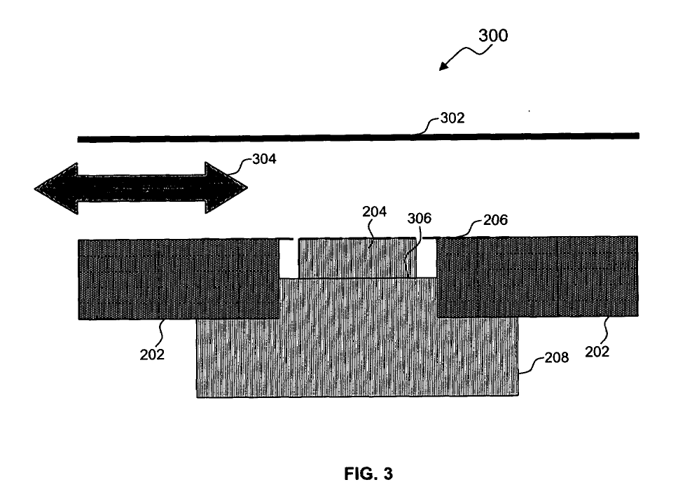

FIG. 3 illustrates a cross-sectional view of a packaging system 300 with an ideal design condition where the sensing plane of the MEMS flow sensor can be located at the same level as the mounting substrate for microelectronic packaging in order to optimize the distance between the sensing plane of a MEMS flow sensor and the mounting substrate, in accordance with a preferred embodiment. Note that in FIGS. 2-3, identical or similar parts or elements are generally indicated by identical reference numerals. The MEMS flow sensor 204 can be first attached to a carrier 208 by utilizing a die 306 attached material. The carrier 208 can be then attached to the mounting substrate 202, and then wire bonded to make the electrical connections. The flow direction of media as indicated by double-arrow 304, along with the top wall of the flow channel 302 and sensing plane of MEMS flow sensor 206 can be associated with the design condition of the package.

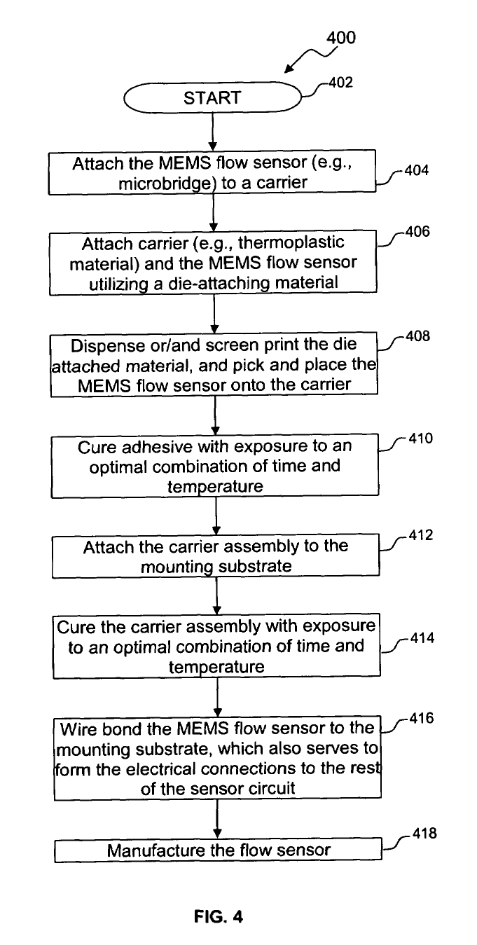

FIG. 4 illustrates a high-level flow chart of operations depicting a microelectronic packaging method 400, which can be followed in order to optimize the distance between the sensing plane of a MEMS flow sensor and the mounting substrate, in accordance with a preferred embodiment. The process begins as depicted at block 402. Next, as indicated at block 404, MEMS flow sensor 204 (e.g., microbridge) can be attached to the carrier 208 illustrated herein with respect to FIGS. 2-3. Thereafter, as described at block 406, the carrier 208, which can be formed from thermoplastic material and the MEMS flow sensor 204 can be attached to the carrier 208 by utilizing a die 306 attaching material.

Thereafter, as indicated at block 408, the attachment process includes dispensing or/and screen printing the die attaching material by picking and placing the MEMS flow sensor 204 on to the carrier 208. The adhesive can be cured with exposure to an optimal combination of time and temperature as depicted in block 410. Thereafter, as indicated at block 412, a resulting carrier assembly can be attached to the mounting substrate 202 Next the carrier assembly can be cured with exposure to an optimal combination of time and temperature as described at block 414. Next, as depicted at block 416, the MEMS flow sensor 204 can be wire bonded to the mounting substrate which also serves to form the electrical connections to the rest of the sensor circuit. Finally, as indicated at block 418, the flow sensor product portfolio can be manufactured.

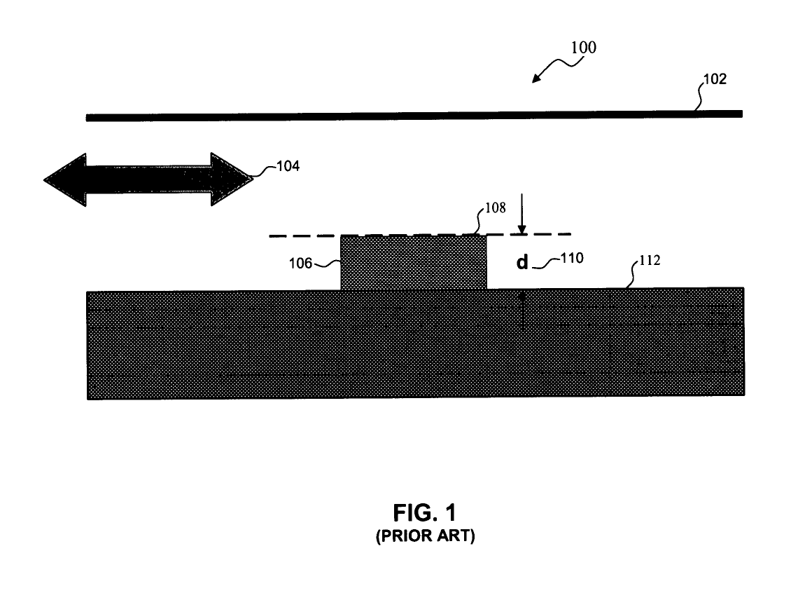

This new micro electronic packaging method FIGS. 2-3 has been developed to minimize the distance between the sensing plane of the MEMS flow sensor 204 and the mounting substrate 202 to minimize flow obstructions and to maintain laminar flow and optimal performance. The distance between the sensing plane of the MEMS flow sensor 204 and the mounting substrate 202 to which it can be mounted and can be optimized to a desired distance by incorporating a carrier 208 as shown in FIGS. 2-3. The distance between the sensing plane of the MEMS flow sensor 204 and the mounting substrate 202 can be easily modified by changing the dimensions of the carrier 208. In prior art, FIG. 1, the packaging means currently employed within flow product portfolio, the MEMS flow sensor 106 is attached directly to a substrate 112 such as ceramic, for example, and is then wire bonded to make the electrical connections. In the new packaging means FIGS. 2-3, the MEMS flow sensor 204 can be first attached to a carrier 208. The carrier 208 can be then attached to the mounting substrate 202, and can be wire bonded to make the electrical connections. The new packaging method (the carrier) adds a significant performance improvement for a very minimal increase in material and processing.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A MEMS-based microelectronic packaging method, comprising:
providing a mounting substrate for a MEMS flow sensor;
minimizing a distance between a sensing plane of said MEMS flow sensor and said mounting substrate;
minimizing a plurality of flow obstructions associated with said MEMS flow sensor; and
maintaining a laminar flow for said MEMS flow sensor based on a relationship between said plurality of flow obstructions and said distance between said sensing plane and said mounting substrate in order to optimize a performance of said MEMS flow sensor.

2. The method of claim 1 further comprising optimizing said distance between said sensing plane of said MEMS flow sensor and said mounting substrate wherein said mounting substrate is mounted to a desired distance by incorporating a carrier.

3. The method of claim 1 further comprising:
attaching said MEMS flow sensor to a carrier utilizing a die-attaching material;
screen printing said die-attaching material;
locating said MEMS flow sensor onto said carrier; and
curing an adhesive with exposure to an optimal combination of time and temperature.

4. The method of claim 1 further comprising:
attaching a carrier assembly to said mounting substrate; and
curing said carrier assembly with an exposure to an optimal combination of time and temperature.

5. The method of claim 1 further comprising wire bonding said MEMS flow sensor to said mounting substrate such that electrical connections associated with said MEMS flow sensor are made available to a remainder of at leas one sensor circuit associated with said MEMS flow sensor.

6. A MEMS-based microelectronic packaging method, comprising:
providing a carrier and a mounting substrate for a MEMS flow sensor;
mounting said MEMS flow sensor to said carrier;
minimizing a distance between a sensing plane of said MEMS flow sensor and said mounting substrate;
minimizing a plurality of flow obstructions associated with said MEMS flow sensor; and
maintaining a laminar flow for said MEMS flow sensor based on a relationship between said plurality of flow obstructions and said distance between said sensing plane and said mounting substrate in order to optimize a performance of said MEMS flow sensor.

7. The method of claim 6 further comprising optimizing said distance between said sensing plane of said MEMS flow sensor and said mounting substrate wherein said mounting substrate is mounted to a desired distance via said carrier.

8. The method of claim 6 further comprising:
attaching said MEMS flow sensor to said carrier utilizing a die-attaching material;
screen printing said die-attaching material;
locating said MEMS flow sensor onto said carrier; and
curing an adhesive with exposure to an optimal combination of time and temperature.

9. The method of claim 6 further comprising:
attaching a carrier assembly to said mounting substrate, wherein said carrier assembly comprises said carrier and associated carrier components; and
curing said carrier assembly with an exposure to an optimal combination of time and temperature.

10. The method of claim 6 further comprising wire bonding said MEMS flow sensor to said mounting substrate such that electrical connections associated with said MEMS flow sensor are made available to a remainder of at leas one sensor circuit associated with said MEMS flow sensor.

11. The method of claim 6 wherein said electrical connections associated with said flow MEMS flow sensor comprise a microbridge.

12. A MEMS-based microelectronic flow sensor system, comprising:
a mounting substrate for a MEMS flow sensor, wherein a distance between a sensing plane of said MEMS flow sensor and said mounting substrate is minimized; and
a plurality of flow obstructions minimized and associated with said MEMS flow sensor, wherein a laminar flow for said MEMS flow sensor is minimized based on a relationship between said plurality of flow obstructions and said distance between said sensing plane and said mounting substrate in order to optimize a performance of said MEMS flow sensor.

13. The system of claim 12 wherein said distance between said sensing plane of said MEMS flow sensor and said mounting substrate is optimized and wherein said mounting substrate is mounted to a desired distance by incorporating a carrier.

14. The system of claim 12 further comprising:
a die-attaching material for attaching said MEMS flow sensor to a carrier, wherein said die-attaching material is screen-printed and wherein said MEMS flow sensor is located and placed onto said carrier; and
an adhesive cured with exposure to an optimal combination of time and temperature.

15. The system of claim 12 further comprising:
a carrier assembly attached to said mounting substrate, wherein said carrier assembly is cured with an exposure to an optimal combination of time and temperature.

16. The system of claim 12 further comprising a wire bond for wire bonding said MEMS flow sensor to said mounting substrate such that electrical connections associated with said MEMS flow sensor are made available to a remainder of at leas one sensor circuit associated with said MEMS flow sensor.

17. A MEMS-based microelectronic flow sensor system, comprising:
a mounting substrate for a MEMS flow sensor, wherein a distance between a sensing plane of said MEMS flow sensor and said mounting substrate is minimized;
a carrier attached to said MEMS flow sensor; and
a plurality of flow obstructions minimized and associated with said MEMS flow sensor, wherein a laminar flow for said MEMS flow sensor is minimized based on a relationship between said plurality of flow obstructions and said distance between said sensing plane and said mounting substrate in order to optimize a performance of said MEMS flow sensor.

18. The system of claim 17 wherein said distance between said sensing plane of said MEMS flow sensor and said mounting substrate is optimized and wherein said mounting substrate is mounted to a desired distance by incorporating said carrier.

19. The system of claim 17 further comprising:
a die-attaching material for attaching said MEMS flow sensor to said carrier, wherein said die-attaching material is screen-printed and wherein said MEMS flow sensor is located and placed onto said carrier; and
an adhesive cured with exposure to an optimal combination of time and temperature.

20. The system of claim 12 further comprising:
a carrier assembly attached to said mounting substrate, wherein said carrier assembly is cured with an exposure to an optimal combination of time and temperature; and
a wire bond for wire bonding said MEMS flow sensor to said mounting substrate such that electrical connections associated with said flow sensor are made available to a remainder of at leas one sensor circuit associated with said MEMS flow sensor.
